(19) United States
(12) Patent Application Publication
(10) Pub. No.: US 2013/0001430 A1
(43) Pub. Date: Jan. 3, 2013

(54) Inspection method and apparatus for shielding container for high-activity waste

(76) Inventor: KUO-YUAN CHANG, Taoyuan County (TW)

(21) Appl. No.: 13/171,454

(22) Filed: Jun. 29, 2011

(51) Int. Cl. G01T 1/16; G21F 5/015

(52) U.S. Cl. 250/395; 250/506.1

(57) ABSTRACT

An inspection method and apparatus for shielding container for high-activity waste is mainly to design the inspection depth of a radiation source in a shielding container and the inspection zone outside the shielding container. It employs a sticking lifting buckle ring at the container cover bottom and a flexible pull string to hang a radiation source inside the shielding container. Between the shielding container and the container cover, there is a compression resistant tube to allow the flexible pull string to pass through and extend outside the shielding container. The flexible pull string allows descending and ascending operation of the radiation source to different height inside the shielding container. The method also includes measuring and recording surface dose rate in each inspection zone outside the shielding container. With the measured surface dose rate from each inspection zone, the method uses a radiation shielding estimation and verification procedure to determine defected shielding container.

### BACKGROUND OF THE INVENTION

1. Field of the Invention

The invention is related to an inspection method and apparatus for shielding container for high-activity waste. Especially, it refers to an inspection method and apparatus to effectively examine whether a shielding container has defects to prevent the use of defected shielding container that will cause radiation leak and affect subsequent handling.

2. Description of the Prior Art

To use a storage container for high-activity radioactive waste, since the container that stores highly radioactive waste needs to meet requirements of transportation and storage, the high-activity radioactive waste is put in a shielding container first to shield high radiation, and then the shielding container is put in the approved storage container; to ensure the radiation shielding effect of the shielding container, the shielding container is subject to shielding source detection, to determine the distribution of radiation dose on shielding container surface at different depth and use the detection result to determine whether the shielding container has defects, further to prevent the use of defected shielding container that could increase personal radiation and affect subsequent waste storage and transportation.

Currently the general traditional shielding inspection method is to use existing radioactive waste for inspection. The method is limited in operational convenience and non-repeatability (once it is loaded with contaminative waste, it needs decontamination process). Besides, the radioactive waste is one-dimensional radiation source, so the shielding container surface is not measured evenly and the accuracy of measurement value is low.

Alternatively, non-destructive testing apparatus is adopted to put the radiation source in the shielding container. This method needs to drill a hole on the top cover of shielding container before putting in the radiation source. Although it can reduce personal radiation dose, the top cover shielding ability can not be accurately measured. Besides, the depth of radiation source in the container cannot be accurately controlled. Thus, the accuracy of measured radiation dose on different areas of the surface is not high.

Both above inspection methods have inconvenience and drawbacks in practical application. Therefore, how to simplify operation process in a convenient and inexpensive fashion to increase efficiency and reduce personal radiation dose is an important subject.

In view of the above drawbacks of the inspection method and apparatus for traditional shielding container, the inventor has invented the new method and apparatus to improve.

### SUMMARY OF THE INVENTION

The main objective for the invention is to provide an inspection method for shielding container for high-activity waste that can effectively simplify operation process, reduce operation time and increase inspection efficiency.

Another objective for the invention is to provide an inspection apparatus for shielding container for high-activity waste that has improved shielding to reduce personal radiation dose, operate with convenience and increase inspection accuracy.

To achieve the above objectives and performance, the technical approaches adopted include: an inspection method which at least comprises the following steps: a. designing the inspection depth for radiation source in shielding container and the inspection zones outside the shielding container; b. moving the radiation source into shielding container and putting a cover on to allow the radiation source to hang onto the cover and extend downward with the cover not interfering with ascending and descending operation; c. operating from outside the shielding container to position the radiation source at different height in the shielding container; d. measuring surface dose rate from each inspection zone outside the shielding container and recording it; e. applying radiation shielding estimation and verification procedure with the above surface dose rate measurement from each inspection zone to determine defected shielding container.

In the above-mentioned method, the radiation shielding estimation and verification procedure at least comprises the following steps: A. at a distance of d0 from the radiation source, measure the dose rate XO; B. verify the material and thickness (t) for shielding container and measurement distance d2, d2=distance from radiation source to inner wall of shielding container d1+shielding container thickness t; C. calculate theoretical dose rate X1 before shielding; D. calculate theoretical dose rate X2 after shielding; E. verify that actual measurement value is smaller than the theoretical dose rate X2 after shielding.

The invention also includes: an inspection apparatus, which is applied to the cover of a shielding container, at least comprises a flexible pull string which one end goes into the shielding container to bond to a radiation source and the other end extends to outside the shielding container; a sticking lifting buckle ring which is located in the middle section of the flexible pull string and attaches to the bottom side of the container cover as a positioning center for the radiation source to hang downward.

For the detailed structure, application principle, function and performance, please refer to the description with the attached figures to get full understanding.

### BRIEF DESCRIPTION OF THE DRAWINGS

FIG. 1 is the operation process flow diagram for the invention.

FIG. 2 is the process flow diagram for radiation shielding estimation and verification for the invention.

FIG. 3 is the illustration for the three-dimensional diagram of the shielding container and the distribution of inspection zones.

FIG. 4 is the cross-sectional view for the shielding container of the invention and the assembly diagram of all inspection apparatus.

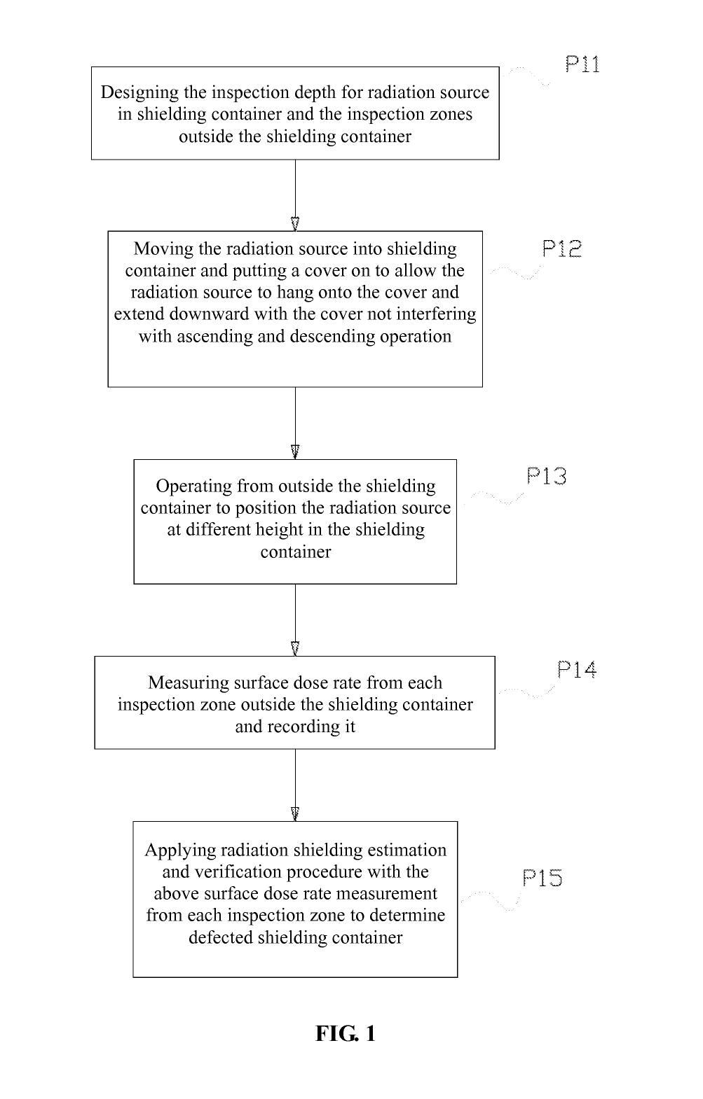

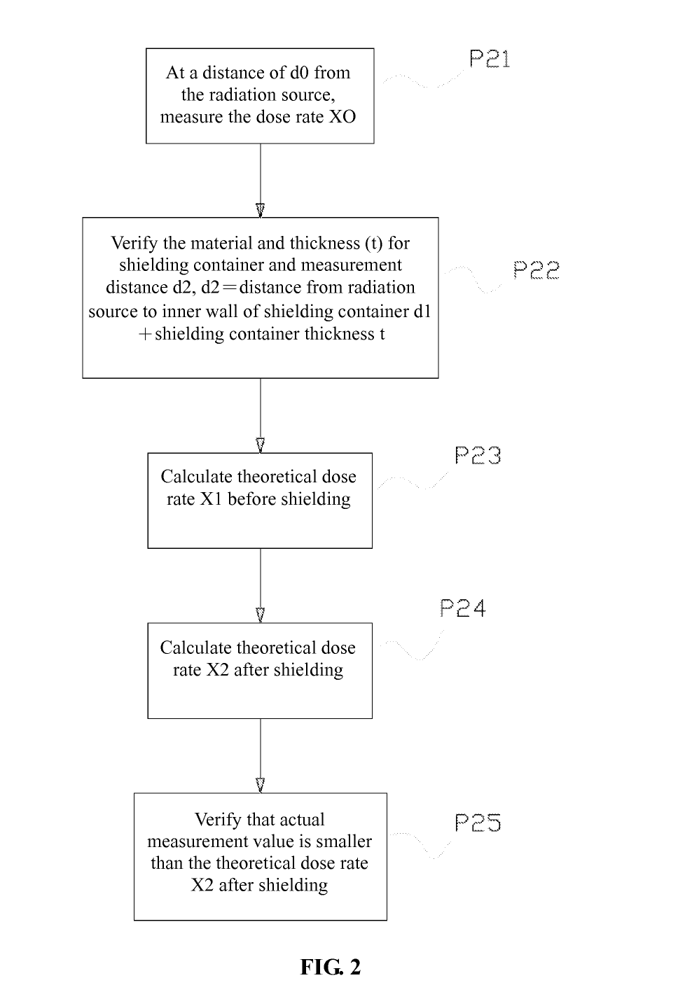

### DETAILED DESCRIPTION OF THE INVENTION

As shown in the figures, the invention mainly employs a shielding container 1 with container cover 10 and the inspection apparatus mainly comprises: a flexible pull string 2, a spring enclosing clamp 3, a sticking lifting buckle ring 4, a compression resistant tube 5 and a spring fixing fastener 6, in which the sticking lifting buckle ring 3 is bonded to the bottom side of the container cover 10, the compression resistant tube 5 is also bonded to the connection area of the container cover 10 and the shielding container 1, the flexible pull string 2 has one end to go into the shielding container 1 and bends downward through the sticking lifting buckle ring 4 to attach to the spring enclosing clamp 3, the spring enclosing clamp 3 is to hold a radiation source 7, the other end of the flexible pull string passes through the compression resistant tube 5 to extend to outside of the shielding container 1 and combine with a spring fixing fastener 6, the spring fixing fastener 6 is attached to different location at the top and bottom of the flexible pull string 2 to allow adjustment of the height of the radiation source 7 (as shown in FIG. 4).

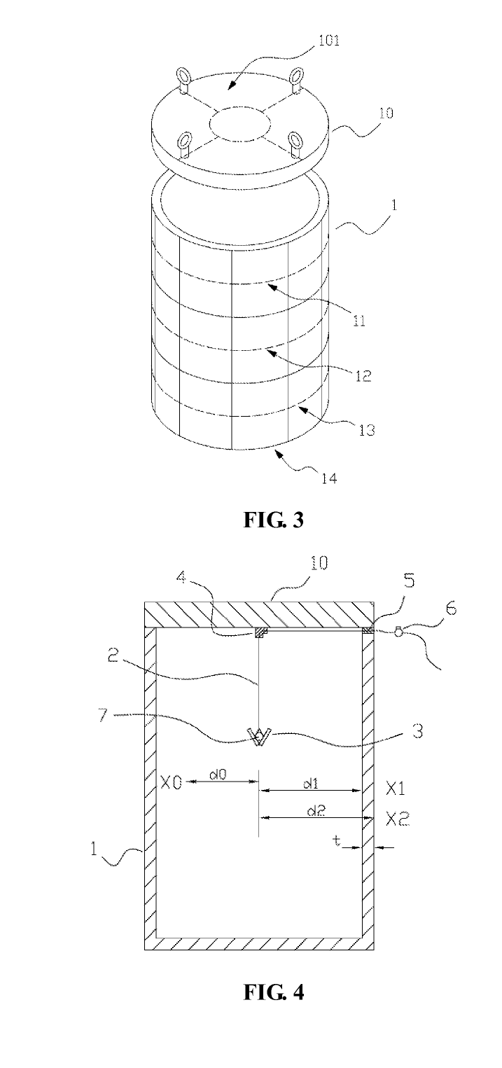

In the following section, the inspection method of the invention will be explained with each operation step. First, design the inspection depth of a radiation source in a shielding container and within the inspection zone outside the shielding container P11 step is to allow different shape distribution of top inspection zone 101 for container cover 10 top, and different shape distribution of top-level inspection zone 11, middle-level inspection zone 12 and bottom-level inspection zone 13 around the shielding container 1, and a bottom inspection zone 14 (as shown in FIG. 3) corresponding to the top inspection zone 101 at the bottom of the shielding container 1; follow the P12 step that move the radiation source into a shielding container and put on the container cover to hang the radiation source downward from the bottom side of the container cover and also prevent the container cover from interfering the upward and downward movement of radiation source; as shown in FIG. 4, complete the assembly of the above mentioned inspection apparatus; follow the P13 step that operate outside the shielding container to move the radiation source to a different height inside the shielding container to allow the radiation source 7 to be placed in different depth (height) inside the shielding container 1; in an actual operation, the radiation source 7 should be at least hung downward to the top-level inspection zone 11, middle inspection zone 12 or bottom inspection zone 13. Then, follow the P14 step that measure surface dose rate in each inspection zone outside the shielding container and record the value to measure and record the surface dose rate for the top inspection zone 101, top-level inspection zone 11, middle-level inspection zone 12, bottom-level inspection zone 13 and the bottom inspection zone 14. At last, follow the P15 step that use the measured surface dose rate for each inspection zone and radiation shielding estimation and verification procedure to determine the defected shielding container to find out the unusual surface dose rate with the radiation shielding estimation and verification procedure and identify the defect location on the shielding container 1 (or container cover 10).

The radiation shielding estimation and verification procedure contains the following steps: first, follow the P12 step that measure the dose rate XO at d0 distance from radiation source to measure dose rate XO at d0 distance from radiation source 7 as the basis of comparison; then, follow the P22 step that verify the material and thickness (t) for shielding container (t) and the measurement distance d2, d2=distance from radiation source to shielding container d1+shielding container thickness t to verify d1 and d2, the distance from the radiation source 7 to the inner wall and outer wall of the shielding container 1; with P23 step that calculate the theoretical dose rate X1 before shielding, use the equation:

Xₒ/X₁=(d₁/d₀)²

to calculate the theoretical dose rate X1 before shielding; then with the P24 step that calculate the theoretical dose rate X2 after shielding, use the equation:

X₂=X₁ e^{-μt},μ=1n2/HVL

in which μ: attenuation coefficient

t: shielding thickness

X₁: dose rate before shielding

X₂: dose rate after shielding

HVL: half-value level of shielding material to calculate the theoretical dose rate X2 for each zone and follow the P25 step that verify that the actual measurement value is smaller than the theoretical dose rate X2 after shielding to verify the measured value of dose rate for each zone and determine if the measured value of surface dose rate is smaller than the theoretical dose rate X2; if not, it is considered as defect.

From the above, it is clear that the inspection method and apparatus for shielding container for high-activity waste in the invention has simple operation process, reduced operation cycle, improved measurement accuracy, industrial utilization value, novelty and progressiveness.

The above mentioned is only one preferred embodiment of the invention and is not to limit the scope of the invention. Those equivalent alterations and modification based on the principle of the invention shall fall into the scope of the claims by the invention.

What is claimed is:

1. An inspection method for shielding container that contains high-activity waste comprises at least the following steps:
a. design the measurement depth for the radiation source inside shielding container and the inspection zone outside the shielding container;
b. move the radiation source into shielding container and put on container cover to allow the radiation source to hang downward from the container cover bottom and prevent the container cover from interfering the upward and downward movement of radiation source;
c. from outside the shielding container, operate to hang the radiation source downward to different height of the shielding container;
d. outside the shielding container, measure and record surface dose rate at each inspection zone;
e. with measured surface dose rate from each inspection zone, follow the procedure of radiation shielding estimation and verification to determine defected shielding container.

2. As described in claim 1 for an inspection method for shielding container that contains high-activity waste, the inspection zone outside the shielding container comprises at least one top-level inspection zone at the top of the shielding container perimeter and one top inspection zone at the top of container cover.

3. As described in claim 1 for an inspection method for shielding container that contains high-activity waste, the inspection zone outside the shielding container comprises at least one bottom-level inspection zone at the bottom of the shielding container perimeter and one bottom inspection zone at the bottom of container cover.

4. As described in claim 1 for an inspection method for shielding container that contains high-activity waste, the inspection zone outside the shielding container comprises at least one middle-level inspection zone at the middle section of the shielding container.

5. As described in claim 1 for an inspection method for shielding container that contains high-activity waste, the radiation shielding estimation and verification procedures comprises at least the following steps:
A. measure dose rate XO at a radiation source d0;
B. verify material and thickness (t) for shielding container and measurement distance d2, d2=distance from radiation source to shielding container inner wall d1+shielding container thickness t;
C. calculate theoretical dose rate X1 before shielding;
D. calculate theoretical dose rate X2 after shielding;
E. verify that the actual measurement value is smaller than the theoretical value X2.

6. As described in claim 5 for an inspection method for shielding container that contains high-activity waste, the theoretical dose rate X1 is obtained by the following equation:
Xₒ/X₁=(d₁/d₀)².

7. As described in claim 5 for an inspection method for shielding container that contains high-activity waste, the theoretical dose rate X2 is obtained by the following equation:
X₂=X₁ e^{-μt},μ=1n2/HVL
in which μ: attenuation coefficient
t: shielding thickness
X₁: dose rate before shielding
X₂: dose rate after shielding
HVL: half-value level of material.

8. An inspection apparatus for shielding container that contains high-activity waste employs a container cover for a shielding container and comprises at least:
one flexible pull string with one end going into the shielding container and combining with a radiation source and the other end extending outside the shielding container;
one sticking lifting buckle ring located in the middle section of the flexible pull string and bonded to the container cover bottom as a positioning center for hanging the radiation source downward.

9. As described in claim 8 for an inspection apparatus for shielding container that contains high-activity waste, between the shielding container and the container cover, there is a compression resistant tube to allow the flexible pull string to pass through and extend outside the shielding container.

10. As described in claim 8 for an inspection apparatus for shielding container that contains high-activity waste, in the extension of the flexible pull string outside the shielding container, there is a spring fixing fastener located at different positions at the top and bottom of the flexible pull string to create different depth for the radiation source.

11. As described in claim 8 for an inspection apparatus for shielding container that contains high-activity waste, in the extension of the flexible pull string inside the shielding container, there is a spring enclosing clamp to grab the radiation source.
